(19) United States
(12) Patent Application Publication
(10) Pub. No.: US 2001/0006031 A1
(43) Pub. Date: Jul. 5, 2001

(54) Slurry for chemical mechanical polishing

(76) Inventors: Yasuaki Tsuchiya, Tokyo (JP); Tetsuyuki Itakura, Tokyo (JP); Shin Sakurai, Tokyo (JP)

Correspondence Address: Paul J. Esatto, Jr., Scully, Scott, Murphy & Presser, 400 Garden City Plaza, Garden City, NY, 11530, US

(21) Appl. No.: 09/741,505

(22) Filed: Dec. 19, 2000

(30) Foreign Application Priority Data
Dec. 28, 1999 (JP) 374488/1999

(51) Int. Cl. C09G 1/02

(52) U.S. Cl. 106/3; 451/41

(57) ABSTRACT

In forming a damascene interconnect made of a copper-containing metal on a barrier metal film made of a tantalum-containing metal, erosion is prevented during chemical mechanical polishing of the copper-containing metal film, by using a polishing slurry comprising at least an alkanolamine represented by general formula (1):

NR¹ₘ(R²OH)ₙ (1)

where R¹ is hydrogen or alkyl having 1 to 5 carbon atoms; R² is alkylene having 1 to 5 carbon atoms; m is an integer of 0 to 2 both inclusive; and n is a natural number of 1 to 3 both inclusive, provided that m+n is 3.

### BACKGROUND OF THE INVENTION

This invention relates to a slurry for chemical mechanical polishing used in manufacturing a semiconductor device. In particular, it relates to a slurry for chemical mechanical polishing suitable for forming a damascene metal interconnect where a tantalum-containing metal is used as a barrier metal film material.

With regard to forming a semiconductor integrated circuit such as ULSI which has been significantly refined and compacted, copper has been expected to be a useful material for electric connection because of its good electromigration resistance and lower electrical resistance.

To date a copper interconnect is formed as follows due to problems such as difficulty in patterning by dry etching. Specifically, a concave such as a trench and a connection hole is formed in an insulating film, a barrier metal film is formed on the surface, a copper film is deposited by plating such that the concave is filled with the material, and then the surface is polished to be flat by chemical mechanical polishing (hereinafter, referred to as “CMP”) until the surface of the insulating film except the concave area is completely exposed, to form electric connections such as a damascene connection interconnect in which the concave is filled with copper, a via plug and a contact plug.

There will be described a process for forming a damascene copper interconnect with reference to FIG. 1.

On a silicon substrate on which a semiconductor device is formed (not shown) is formed a lower interconnect layer 1 made of an insulating film comprising a lower interconnect (not shown). Then, as shown in FIG. 1(a) are sequentially formed a silicon nitride film 2 and a silicon oxide film 3. On the silicon oxide film 3 is formed a concave having an interconnect pattern and reaching the silicon nitride film 2.

Then, as shown in FIG. 1(b), a barrier metal film 4 is formed by sputtering. On the film is formed a copper film 5 over the whole surface by plating such that the concave is filled with the material.

As shown in FIG. 1(c), the copper film 5 is polished by CMP to make the substrate surface flat. Polishing by CMP is continued until the metal over the silicon oxide film 3 is completely removed, as shown in FIG. 1(d).

In the above process for forming a damascene copper interconnect, a barrier metal film is formed as a base film for, e.g., preventing diffusion of copper into the insulating film. However, when using a tantalum metal such as Ta and TaN as a barrier metal film, there is a problem that a polishing rate for the barrier metal film made of Ta or TaN is smaller than that for the copper film using a conventional polishing slurry due to extreme chemical stability of Ta and TaN. Specifically, when forming, e.g., a damascene copper interconnect by CMP using a conventional polishing slurry, there is a significant difference between the polishing rates for the copper film and the barrier metal film, which may cause dishing and erosion.

Dishing is a phenomenon that copper in the concave is excessively polished so that the center of the copper film in the concave is depressed in relation to the plane of the insulating film on the substrate, as shown in FIG. 2. A conventional polishing slurry requires an adequately much polishing time for completely removing the barrier metal film 4 on the insulating film (silicon oxide film 3) because of a lower polishing rate for the barrier metal film. The polishing rate for the copper film 5 is higher than that for the barrier metal film 4, so that the copper film 5 is excessively polished, resulting in dishing.

Erosion is a phenomenon that polishing in a dense interconnect area excessively proceeds in relation to that in a sparse area such as an isolated interconnect area so that the surface of the dense interconnect area becomes depressed in relation to the other surfaces, as shown in FIG. 1(d). When the dense interconnect area comprising many damascenes in the copper film 5 is considerably separated from the isolated interconnect area comprising less damascenes in the copper film 5 by, for example, an area without interconnects within the wafer, and the copper film 5 is polished faster than the barrier metal film 4 or a silicon oxide film 3 (the insulating film), then a polishing pad pressure to the barrier metal film 4 or the silicon oxide film 3 in the dense interconnect area becomes higher than that in the isolated interconnect area. As a result, in the CMP process after exposing the barrier metal film 4 (the process of FIG. 1(c) and thereafter), there generates a difference in a polishing rate by CMP between the dense interconnect area and the isolated interconnect area, so that the insulating film in the dense interconnect area is excessively polished, resulting in erosion.

Dishing in the process for forming an electric connection part in a semiconductor device as described above, may cause increase in an interconnection resistance and a connection resistance, and tends to cause electromigration, leading to poor reliability in the device. Erosion may adversely affect flatness in the substrate surface, which becomes more prominent in a multilayer structure, causing problems such as increase and dispersion in an interconnect resistance.

JP-A 8-83780 has described that dishing in a CMP process may be prevented by using a polishing slurry containing benzotriazole or its derivative and forming a protective film on a copper surface. JP-A 11-238709 has also described that a triazole compound is effective for preventing dishing.

JP-A 10-44047 has described in its Examples that CMP may be conducted using a polishing slurry containing an alumina polishing material, ammonium persulfate (an oxidizing agent) and a particular carboxylic acid to increase a difference in a polishing rate between an aluminum layer for interconnection and a silicon oxide film and to increase a removal rate for a titanium film as a barrier metal film. The technique in the Examples cannot, however, solve the problem of erosion when using a tantalum metal as a barrier metal film.

JP-A 10-46140 has described a polishing composition comprising a particular carboxylic acid, an oxidizing agent and water whose pH is adjusted by an alkali to 5 to 9. This publication has disclosed improvement in a polishing rate and prevention of dishing associated with corrosion mark as effects of addition of a particular carboxylic acid such as malic acid, and there are no descriptions for polishing a barrier metal film or erosion.

JP-A 10-163141 has disclosed a polishing composition for a copper film containing a polishing material and water, further comprising an iron (III) compound dissolved in the composition. Examples in the publication has described that a polishing rate for a copper film may be improved and surface defects such as dishing and scratches may be prevented, by using colloidal silica as a polishing material and iron (III) citrate, ammonium iron (III) citrate or ammonium iron (III) oxalate as an iron (III) compound. This publication, however, also has no descriptions about polishing a barrier metal film made of a tantalum metal or erosion.

JP-A 11-21546 has disclosed a slurry for chemical mechanical polishing comprising urea, a polishing material, an oxidizing agent, a film-forming agent and a complex-forming agent. Examples in this publication have described polishing Cu, Ta and PTEOS using a slurry having pH 7.5 prepared using alumina as a polishing material, hydrogen peroxide as an oxidizing agent, benzotriazole as a film-forming agent and tartaric acid or ammonium oxalate as a complex-forming agent. The publication, however, has described only that addition of the complex-forming agent such as tartaric acid and ammonium oxalate is effective for disturbing a passive layer formed by a film-forming agent such as benzotriazole and for limiting a depth of an oxidizing layer. It has described about Ta and TaN as examples for a barrier metal, but there are no descriptions about polishing for a barrier metal film made of a tantalum metal or erosion.

Thus, techniques for preventing dishing are known, but no techniques for prevention of erosion are known. In particular, erosion in CMP has been a serious problem for forming a copper damascene interconnect using a tantalum metal film as a barrier metal film.

### SUMMARY OF THE INVENTION

An objective of this invention is to provide a slurry for chemical mechanical polishing, which can prevent erosion in CMP to form a damascene interconnect with a small dispersion in an interconnect resistance when forming a copper damascene interconnect using a tantalum-containing metal film as a barrier metal film.

To achieve the objective, this invention provide a slurry for chemical mechanical polishing for polishing a copper-containing metal film formed on a tantalum-containing metal film, comprising a polishing grain, an oxidizing agent, an organic acid and an alkanolamine represented by general formula (1):

NR¹ₘ(R²OH)ₙ (1)

where R¹ is hydrogen or alkyl having 1 to 5 carbon atoms; R² is alkylene having 1 to 5 carbon atoms; m is an integer of 0 to 2 both inclusive; and n is a natural number of 1 to 3 both inclusive, provided that m+n is 3.

A polishing slurry of this invention may reduce a polishing rate for a tantalum-containing metal film and increase its difference to that for a copper-containing metal film, which may improve the function of the tantalum-containing metal film as a stop film in polishing the copper-containing metal film (a polishing stopper). As a result, it can prevent erosion by CMP to form a damascene interconnect with a small dispersion in an interconnect resistance when forming a copper-containing metal damascene interconnect using a tantalum-containing metal film as a barrier metal film.

Herein, a copper-containing metal refers to copper or an alloy mainly containing copper, and a tantalum-containing metal refers to tantalum (Ta) or tantalum nitride (TaN).

### BRIEF DESCRIPTION OF THE DRAWINGS

FIG. 1 is a process cross section illustrating a process according to the prior art for forming a damascene copper interconnect.

FIG. 2 shows a cross section of an interconnect when forming a damascene copper interconnect using a slurry for chemical mechanical polishing according to the prior art.

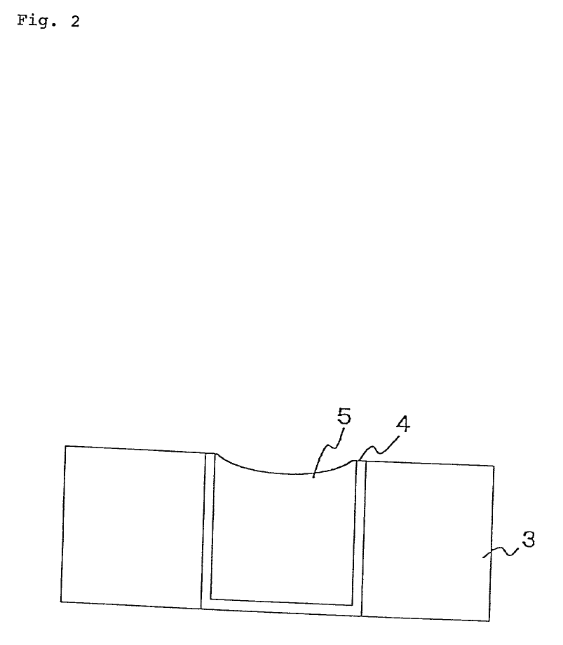

FIG. 3 is a process cross section illustrating a process for forming a damascene copper interconnect using a slurry for chemical mechanical polishing according to this invention.

### DETAILED DESCRIPTION

There will be described preferred embodiments of this invention.

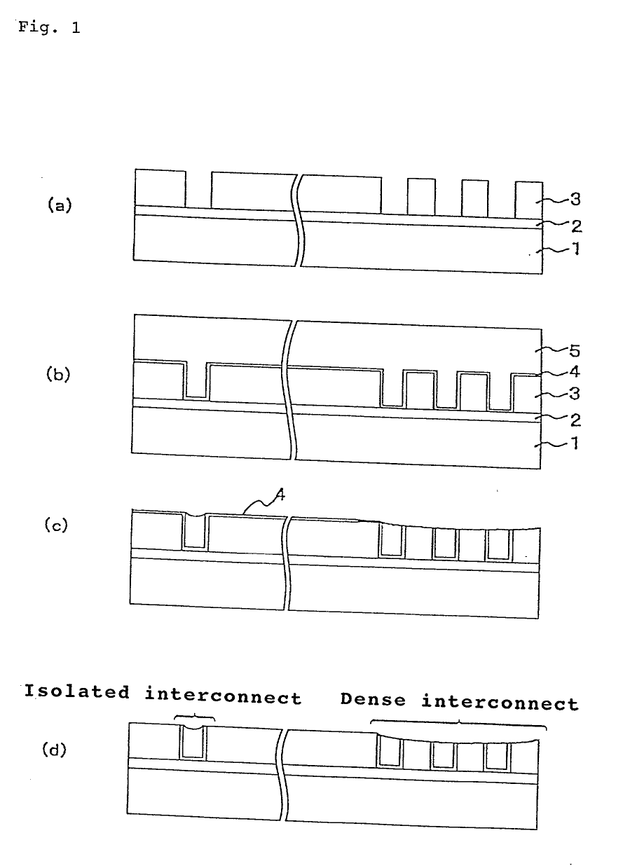

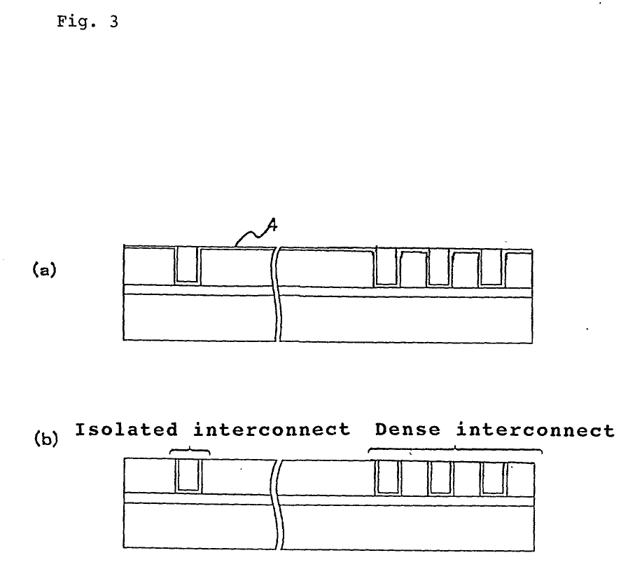

A polishing slurry of this invention comprising an alkanolamine may be suitably used in forming a copper metal damascene interconnect comprising a tantalum metal film as a barrier metal film. In CMP of the surface of a substrate in which a barrier metal film 4 is formed on an insulating film 3 having a concave and a copper metal film 5 is formed over the whole surface such that the concave is filled with the metal as shown in FIG. 1(b), a polishing slurry of this invention may be used to allow a barrier metal film 4 made of a tantalum metal to act as a substantial stop film in polishing a copper metal film as shown in FIG. 3(a), leading to prevention of erosion.

After terminating CMP with a barrier metal film 4 made of a tantalum metal, CMP may be continued replacing the polishing slurry with a polishing slurry exhibiting a relatively higher polishing rate for a tantalum metal film to form a copper metal damascene interconnect in which erosion is prevented, as shown in FIG. 3(b).

Examples of the alkanolamine represented by general formula (1) include methanolamine, dimethanolamine, trimethanolamine, ethanolamine, diethanolamine, triethanolamine, propanolamine, dipropanolamine, tripropanolamine, butanolamine, dibutanolamine, tributanolamine, N-methylethanolamine, N-ethylethanolamine, N-propylethanolamine and N-butylethanolamine. Among these alkanolamines, ethanolamine, diethanolamine and triethanolamine are preferable and triethanolamine is more preferable because of their higher solubility in an aqueous medium and their higher effect of reduction in a polishing rate for the tantalum-containing metal film.

For the purpose of minimizing polishing of the tantalum metal film, the content of the above particular alkanolamine used in this invention is preferably at least 0.01 wt %, more preferably at least 0.2 wt %, further preferably at least 0.5 wt % to the whole amount of the polishing slurry, while for the purpose of preventing an excessively higher pH of the polishing slurry, it is preferably 10 wt % or less, more preferably 5 wt % or less, further preferably 2 wt % or less.

The alkanolamine in the polishing slurry of this invention is believed to intervene between the polished surface of the tantalum metal film and polishing grains for improving lubricity of the polished surface. Thus, the slurry of this invention may be used to improve slipperiness of the polishing grains on the polished surface, leading to reduction in a mechanical polishing effect with polishing grains. Since a tantalum metal is inherently chemically stable, mechanical polishing is predominant in CMP for a tantalum metal film while contribution of chemical polishing is small. Thus, the alkanolamine-containing polishing slurry of this invention may minimize mechanical polishing for the tantalum metal film, i.e., it may reduce a CMP rate for the tantalum metal film. On the other hand, in CMP for the copper metal film, contribution of chemical polishing is adequately large to prevent excessive reduction in a polishing rate for the copper metal film. As a result, the polishing slurry of this invention may reduce a polishing rate for the tantalum metal film while increasing a difference in a polishing rate between the tantalum metal film and the copper metal film, to enhance the function of the barrier metal film made of the tantalum metal as a stop film (a polishing stopper) in polishing of the copper metal film.

A polishing grain contained in a polishing slurry of this invention may be selected from the group consisting of aluminas such as α-alumina, θ-alumina, γ-alumina and fumed alumina; silicas such as fumed silica and colloidal silica; titania; zirconia; germania; ceria; and a combination of two or more of these metal oxide polishing grains. Among these, silica and alumina are preferable.

The content of the polishing grain contained in the polishing slurry of this invention is preferably at least 1 wt %, more preferably at least 3 wt %; and preferably 30 wt % or less, more preferably 10 wt % or less to the total amount of the slurry for chemical mechanical polishing. When the polishing slurry contains two or more types of polishing grains, the sum of the contents of the individual polishing grains is preferably at least 1 wt %, more preferably at least 3 wt %; and preferably 30 wt % or less, more preferably 10 wt % or less.

The oxidizing agent contained in the polishing slurry of this invention may be selected from known water-soluble oxidizing agents in the light of polishing accuracy and a polishing efficiency. For example, those which may not cause heavy-metal ion contamination include peroxides such as H₂O₂, Na₂O₂, Ba₂O₂ and (C₆H₅C)₂O₂; hypochlorous acid (HClO); perchloric acid; nitric acid; ozone water; and organic acid peroxides such as peracetic acid and nitrobenzene. Among these, hydrogen peroxide (H₂O₂) is preferable because it does not contain a metal component and does not generate a harmful byproduct. The content of the oxidizing agent in the polishing slurry of this invention is preferably at least 0.01 wt %, more preferably at least 0.05 wt %, further preferably at least 0.1 wt % for achieving adequate effects of its addition; and preferably 15 wt % or less, more preferably 10 wt % or less for preventing dishing and adjusting a polishing rate to a proper value. When using an oxidizing agent which is relatively susceptible to deterioration with age such as hydrogen peroxide, it may be possible to separately prepare a solution containing an oxidizing agent at a given concentration and a composition which provides a given polishing slurry after addition of the solution containing an oxidizing agent, which are then combined just before use.

For an organic acid, a carboxylic acid or an amino acid may be added as a proton donor for enhancing oxidization by the oxidizing agent and achieving stable polishing.

Examples of a carboxylic acid include oxalic acid, malonic acid, tartaric acid, malic acid, glutaric acid, citric acid, maleic acid, formic acid, acetic acid, propionic acid, butyric acid, valeric acid, acrylic acid, lactic acid, succinic acid, nicotinic acid, their salts and a mixture thereof.

An amino acid may be added as a free form, as a salt or as a hydrate. Examples of those which may be added include arginine, arginine hydrochloride, arginine picrate, arginine flavianate, lysine, lysine hydrochloride, lysine dihydrochloride, lysine picrate, histidine, histidine hydrochloride, histidine dihydrochloride, glutamic acid, glutamic acid hydrochloride, sodium glutaminate monohydrate, glutamine, glutathione, glycylglycine, alanine, β-alanine, γ-aminobutyric acid, ε-aminocarproic acid, aspartic acid, aspartic acid monohydrate, potassium aspartate, potassium aspartate trihydrate, tryptophan, threonine, glycine, cystine, cysteine, cysteine hydrochloride monohydrate, oxyproline, isoleucine, leucine, methionine, ornithine hydrochloride, phenylalanine, phenylglycine, proline, serine, tyrosine, valine, and a mixture of these amino acids.

The content of the organic acid is preferably at least 0.01 wt %, more preferably at least 0.05 wt % to the total amount of the polishing slurry for achieving adequate effects of its addition; and preferably 5 wt % or less, more preferably 3 wt % or less for preventing dishing and adjusting a polishing rate to a proper value. When two or more organic acids are combined, the above content means the sum of the contents of the individual organic acids.

Preferably the polishing slurry of this invention further comprises an antioxidant. Addition of an antioxidant may allow a polishing rate for a copper metal film to be easily adjusted and may result in forming a coating film over the surface of the copper metal film to prevent dishing. Therefore, when the polishing slurry comprises both an alkanolamine and an antioxidant, it may prevent both erosion and dishing. Addition of an alkanolamine and an antioxidant to the polishing slurry may allow us to adjust polishing rates for a tantalum metal film and a copper metal film independently and thus to control a polishing rate ratio of the copper-containing metal film/the tantalum-containing metal film within a wide range.

Examples of an antioxidant include benzotriazole, 1,2,4-triazole, benzofuroxan, 2,1,3-benzothiazole, o-phenylenediamine, m-phenylenediamine, cathechol, o-aminophenol, 2-mercaptobenzimidazole, 2-mercaptobenzoxazole, melamine, and their derivatives. Among these, benzotriazole and its derivatives are preferable. Examples of a benzotriazole derivative include substituted benzotriazoles having a benzene ring substituted with hydroxy; alkoxy such as methoxy and ethoxy; amino; nitro; alkyl such as methyl, ethyl and butyl; halogen such as fluorine, chlorine, bromine and iodine. Furthermore, naphthalenetriazole and naphthalenebistriazole as well as substituted naphthalenetriazoles and substituted naphthalenebistriazoles substituted as described above may be used.

The content of the antioxidant is preferably at least 0.0001 wt %, more preferably at least 0.001 wt % to the total amount of the polishing slurry for achieving adequate effects of its addition; and preferably 5 wt % or less, more preferably 2.5 wt % or less for adjusting a polishing rate to a proper value.

In the light of a polishing rate and corrosion, a slurry viscosity and dispersion stability of a polishing material, a polishing slurry of this invention has a pH of preferably at least 3, more preferably at least 4; and preferably 9 or less, more preferably 8 or less for increasing a viscosity of the polishing slurry.

For the polishing slurry, pH may be adjusted by a known technique. For example, an alkali may be directly added to a slurry in which polishing grains are dispersed and a carboxylic acid is dissolved. Alternatively, a part or all of an alkali to be added may be added as a carboxylic acid alkali salt. Examples of an alkali which may be used include alkali metal hydroxides such as sodium hydroxide and potassium hydroxide; alkali metal carbonates such as sodium carbonate and potassium carbonate; ammonia; and amines.

A polishing slurry of this invention may contain a variety of additives such as buffers and viscosity modifiers commonly added to a polishing slurry as long as it does not deteriorate the properties of the slurry.

In a polishing slurry of this invention, a composition may be preferably adjusted to provide a polishing rate for a tantalum-containing metal film of preferably 15 nm/min or less, more preferably 10 nm/min or less, further preferably 5 nm/min or less, most preferably 3 nm/min or less; and to provide a polishing rate for copper-containing metal film of preferably 300 nm/min or more, more preferably 400 nm/min or more, and preferably 1500 nm/min or less, more preferably 1000 nm/min or less.

A polishing rate ratio of the copper-containing metal film to the tantalum-containing metal film (Cu/Ta polishing ratio) is preferably 30/1 or more, more preferably 50/1 or more, further preferably 100/1 or more in the light of uniform CMP of the copper metal film irrespective of an interconnect pattern made of the copper metal within a wafer surface.

A polishing slurry of this invention may be prepared by a common process for preparing a free grain aqueous polishing slurry. Specifically, polishing grains are added to an aqueous medium to an appropriate amount. A dispersing agent may be, if necessary, added to an appropriate amount. In the state, the polishing grains are aggregated. Thus, the aggregated polishing particles are dispersed into particles with a desired particle size. The dispersion process may be conducted using, for example, an ultrasonic disperser, a bead mill disperser, a kneader disperser and a ball mill disperser.

A polishing slurry of this invention may be most effectively used for forming an electric connection part such as a damascene interconnect, a via plug and a contact plug by CMP of a substrate in which a tantalum metal film as a barrier metal film is formed on an insulating film having a concave and a copper metal film is formed over the whole surface such that the concave is filled with the metal. Examples of an insulating film include a silicon oxide film, a BPSG film and an SOG film. A copper alloy may be an alloy mainly containing copper together with a metal such as silver, gold, platinum, titanium, tungsten and aluminum.

CMP using a polishing slurry of this invention may be, for example, conducted as follows, using a common CMP apparatus. A wafer on which a copper-containing metal film is formed is placed on a spindle wafer carrier. The surface of the wafer is contacted with a polishing pad made of porous urethane adhered on a rotary plate (surface plate). While supplying a polishing slurry to the surface of the polishing pad from a polishing slurry inlet, both the wafer and the polishing pad are rotated to polish the wafer. If necessary, a pad conditioner is contacted with the surface of the polishing pad to condition the surface of the polishing pad.

Removal of the copper-containing metal film and exposure of the tantalum-containing metal film may be detected by a variety of methods.

As first example of such a method, a polishing rate for a copper-containing metal film is determined in advance to estimate a time required for removing a copper-containing metal film with a given thickness. After initiating CMP, CMP of the copper-containing metal film is terminated after a given time from the time when the estimated period elapses.

As second example, since a tantalum-containing metal film acts as a stop film when using a polishing slurry of this invention, CMP is conducted while measuring a polishing rate and CMP is terminated after a given time from the time when the polishing rate begins to rapidly decrease.

As third example, CMP is conducted while measuring change in a rotation torque to a rotation axis with a rotation torque meter placed on the rotation axis of the rotary plate. Then, polishing of the copper-containing metal film is terminated after a given time from the time when change is detected in a rotation torque associated with exposure of the tantalum-containing metal film by removing the copper-containing metal film. In other words, while the rotation torque is stable during polishing the copper-containing metal film, it reduces when the tantalum-containing metal film is exposed. CMP is, therefore, terminated after a given period from the time when the rotation torque reduces.

As fourth example, light is irradiated to a polished surface of a substrate to conduct CMP while measuring reflected light. Specifically, as CMP proceeds from a copper metal film and then to a tantalum metal film, a metal exposed in the polished surface is changed, resulting in change in reflected light. CMP is, therefore, terminated after a given time from the time when the intensity of the reflected light changes.

In CMP of a copper-containing metal film formed on a tantalum-containing metal film, a polishing slurry of this invention may be used to significantly improve the function of the tantalum-containing metal film as a stop film, so that CMP may be prevented after the time when the tantalum-containing metal film is exposed, even when polishing is excessively conducted. Consequently, erosion may be prevented and thus the substrate surface may be adequately flat to prevent/minimize increase and dispersion of an interconnect resistance.

At the end of CMP of the copper-containing metal film, CMP of the tantalum-containing metal film is conducted replacing the polishing slurry with a slurry exhibiting a relatively lower polishing rate for the copper-containing metal film. Such a slurry may be a polishing slurry without an alkanolamine.

A polishing slurry comprising silica polishing grains and a carboxylic acid intramolecularly having two or more carboxyl groups may be used as a polishing slurry for polishing a tantalum metal film. The carboxylic acid exhibits aggregation effect (flocculation) to silica particles dispersed in water, so that the aggregated silica particles by the carboxylic acid enhances mechanical polishing, leading to improved polishing of the tantalum-containing metal film. Examples of such a carboxylic acid which may be used include oxalic acid, malonic acid, tartaric acid, malic acid, glutaric acid, citric acid, maleic acid, their salts and mixtures of two or more thereof.

A polishing slurry comprising silica polishing grains and an inorganic salt may be used as a polishing slurry for polishing a tantalum-containing metal film. The inorganic salt exhibits aggregation effect (flocculation) to silica particles dispersed in water, so that the aggregated silica particles by the inorganic salt enhances mechanical polishing, leading to improved polishing of the tantalum metal film. Examples of such an inorganic salt which may be used include potassium sulfate, ammonium sulfate, potassium chloride, ammonium chloride, potassium peroxodisulfate, ammonium peroxodisulfate, potassium periodate, ammonium periodate and mixtures of two or more thereof.

This invention will be more specifically described with reference to Examples.

### CMP test

A substrate on which a tantalum film and a copper film were deposited was prepared as follows. On a 6 inch wafer (silicon substrate, not shown) in which a semiconductor device such as a transistor was formed was deposited a lower interconnect layer 1 made of a silicon oxide film comprising a lower interconnect (not shown). On the lower interconnect layer was, as shown in FIG. 1(a), formed a silicon nitride film 2, on which was formed a silicon oxide film 3 with a thickness of about 500 nm. The silicon oxide film 3 was patterned by photolithography and reactive ion etching as usual to form a trench for interconnection and a connection hole with a width of 0.23 to 10 μm and a depth of 500 nm. Then, as shown in FIG. 1(b), Ta film 4 was formed to a thickness of 50 nm by sputtering, a Cu film was formed to a thickness of about 50 nm by sputtering, and then a copper film 5 was formed to a thickness of about 800 nm by plating.

CMP was conducted using a Speedfam-Ipec Type SH-24 apparatus. The polisher was used, on whose surface plate a polishing pad (Rodel-Nitta IC 1400) was attached. Polishing conditions were as follows: a polishing load (a contact pressure of the polishing pad): 27.6 kPa; a rotating speed of the surface plate: 55 rpm; a carrier rotating speed: 55 rpm; and a polishing slurry feeding rate: 100 mL/min.

Polishing rates for a tantalum and a copper films were determined as follows. Four needle electrodes were aligned on a wafer with a given interval. A given current was applied between the outer two probes to detect a potential difference between two inner probes for determining a resistance (R′) and further the value is multiplied by a correction factor RFC (Resistivity Correction Factor) to a surface resistivity (ρs′). A surface resistivity (ρs) is determined for a wafer film whose thickness (T) (nm) is known. The surface resistivity is inversely proportional to the thickness. Thus, when a thickness for a surface resistivity of ρs′ is d, an equation d(nm)=(ρs× T)/ρs′ holds true. using the equation, the thickness d can be determined. Furthermore, a variation between before and after polishing was divided by a polishing time to estimate a polishing rate. A surface resistivity was determined using Mitsubishi Chemical Industries Four Probe Resistance Detector (Loresta-GP).

### EXAMPLES 1 TO 6

As shown in Table 1, a polishing slurry was prepared, which comprised 5 wt % of θ alumina (Sumitomo Chemical Industries; AKP-G008), 1.5 wt % of citric acid (Kanto Chemical Co.), 2.5 wt % of H₂O₂ (Kanto Chemical Co.) and 0.01 to 10 wt % of triethanolamine (Kanto Chemical Co.) and whose pH was adjusted to 5.5 with KOH. H₂O₂ was added just before use.

As a comparative 1, a polishing slurry was prepared as described in Examples 1 to 6, omitting an alkanolamine.

Using these polishing slurries, CMP was conducted and the results are shown in Table 1. As seen in Table 1, addition of triethanolamine significantly reduced a polishing rate for a tantalum film. Analysis of the state of the substrate after polishing by a step meter and observation of the cross section of the substrate by SEM indicated that erosion was prevented. These results show that any of the polishing slurries in Examples 1 to 6 can be used for polishing a copper film to allow a tantalum layer thereunder to act as a stop film.

### EXAMPLES 7 AND 8

As shown in Table 1, a polishing slurry was prepared as described in Example 3, replacing triethanolamine with diethanolamine or ethanolamine.

Using the polishing slurry, a CMP test was conducted. The results are shown in Table 1. As seen from Table 1, addition of diethanolamine or ethanolamine also significantly reduced a polishing rate for the tantalum film. Analysis of the state of the substrate after polishing by a step meter and observation of the cross section of the substrate by SEM indicated that erosion was prevented.

### EXAMPLE 9

As shown in Example 9 in Table 1, a polishing slurry was prepared as described in Example 3, replacing alumina with fumed silica Qs-9 (Tokuyama) as abrasion grains.

As Comparative Example 2, a polishing slurry was prepared as described in Example 9, omitting an alkanolamine.

Using these polishing slurries, a CMP test was conducted. The results are shown in Table 1. As seen from Table 1, when using silica as abrasion grains, addition of triethanolamine also significantly reduced a polishing rate for the tantalum film. Analysis of the state of the substrate after polishing by a step meter and observation of the cross section of the substrate by SEM indicated that erosion was prevented.

### EXAMPLES 10 TO 13

Polishing slurries were prepared as described in Example 3, replacing citric acid with the organic acids indicated in Examples 10 to 13 in Table 1.

Using these polishing slurries, a CMP test was conducted. The results are shown in Table 1. As seen from Table 1, when using an organic acid other than citric acid, addition of triethanolamine also significantly reduced a polishing rate for the tantalum film. Analysis of the state of the substrate after polishing by a step meter and observation of the cross section of the substrate by SEM indicated that erosion was prevented.

TABLE 1

| | | | | Ta |
|---|---|---|---|---|
| | | | | polishing |
| | Polishing | Organic acid | Alkanolamine | rate |
| | grain (wt %) | (wt %) | (wt%) | (nm/min) |
| Example 1 | Alumina | Citric acid | Triethanolamine | 9.75 |
| | (5) | (1.5) | (0.01) | |
| Example 2 | Alumina | Citric acid | Triethanolamine | 4.67 |
| | (5) | (1.5) | (0.50) | |
| Example 3 | Alumina | Citric acid | Triethanolamine | 3.48 |
| | (5) | (1.5) | (1.00) | |
| Example 4 | Alumina | Citric acid | Triethanolamine | 2.11 |
| | (5) | (1.5) | (2.00) | |
| Example 5 | Alumina | Citric acid | Triethanolamine | 1.02 |
| | (5) | (1.5) | (5.00) | |
| Example 6 | Alumina | Citric acid | Triethanolamine | 0.53 |
| | (5) | (1.5) | (10.00) | |
| Example 7 | Alumina | Citric acid | Diethanolamine | 3.12 |
| | (5) | (1.5) | (1.00) | |
| Example 8 | Alumina | Citric acid | Ethanolamine | 1.89 |
| | (5) | (1.5) | (1.00) | |
| Example 9 | Silica | Citric acid | Triethanolamine | 2.11 |
| | (5) | (1.5) | (1.00) | |
| Example 10 | Alumina | Glutaric | Triethanolamine | 3.69 |
| | (5) | acid | (1.00) | |
| | | (1.5) | | |
| Example 11 | Alumina | Tartaric | Triethanolamine | 3.45 |
| | (5) | acid | (1.00) | |
| | | (1.5) | | |
| Example 12 | Alumina | Malic acid | Triethanolamine | 3.53 |
| | (5) | (1.5) | (1.00) | |
| Example 13 | Alumina | Glycine | Triethanolamine | 3.73 |
| | (5) | (1.5) | (1.00) | |
| Comparative | Alumina | Citric acid | None | 16.18 |
| Example 1 | (5) | (1.5) | | |
| Comparative | Silica | Citric acid | None | 77.4 |
| Example 2 | (5) | (1.5) | | |

### EXAMPLES 14 TO 19

Polishing slurries were prepared as described in Examples 1 to 6, using a mixed acid consisting of 0.16 wt % of glutaric acid, 1.5 wt % of citric acid and 0.3 wt % of glycine as an organic acid and adding 0.005 wt % of benzotriazole as an antioxidant.

As Comparative Example 3, a polishing slurry was prepared as described in Examples 14 to 19, omitting an alkanolamine.

Using these polishing slurries, a CMP test was conducted. The results are shown in Table 2. As seen from Table 2, a polishing rate for the tantalum film was significantly reduced ad a polishing rate ratio of the copper film to the tantalum film was significantly improved. In other words, it was found that addition of triethanolamine improved polishing selectivity to the copper film. Analysis of the state of the substrate after polishing by a step meter and observation of the cross section of the substrate by SEM indicated that erosion and dishing were prevented.

TABLE 2

| | Polishing | | | | | Cu polishing | Polishing |
|---|---|---|---|---|---|---|---|
| | grain | Organic acid | Antioxidant | Alkanolamine | Ta polishing | rate | rate ratio: |
| | (wt %) | (wt %) | (wt %) | (wt %) | rate (nm/min) | (nm/min) | Cu/Ta |
| Example 14 | Alumina | Mixed acid | Benzotriazole | Triethanolamine | 9.89 | 1040.5 | 105 |
| | (5) | (1.96) | (0.005) | (0.01) | | | |
| Example 15 | Alumina | Mixed acid | Benzotriazole | Triethanolamine | 4.55 | 1013.2 | 223 |
| | (5) | (1.96) | (0.005) | (0.50) | | | |
| Example 16 | Alumina | Mixed acid | Benzotriazole | Triethanolamine | 3.48 | 911.1 | 262 |
| | (5) | (1.96) | (0.005) | (1.00) | | | |
| Example 17 | Alumina | Mixed acid | Benzotriazole | Triethanolamine | 2.05 | 808.8 | 395 |
| | (5) | (1.96) | (0.005) | (2.00) | | | |
| Example 18 | Alumina | Mixed acid | Benzotriazole | Triethanolamine | 1.03 | 543.7 | 528 |
| | (5) | (1.96) | (0.005) | (5.00) | | | |
| Example 19 | Alumina | Mixed acid | Benzotriazole | Triethanolamine | 0.47 | 387.6 | 825 |
| | (5) | (1.96) | (0.005) | (10.00) | | | |
| Comparative | Alumina | Mixed acid | Benzotriazole | None | 15.32 | 1060.8 | 69 |
| Example 3 | (5) | (1.96) | (0.005) | | | | |

What is claimed is:

1. A slurry for chemical mechanical polishing for polishing a copper-containing metal film formed on a tantalum-containing metal film, comprising a polishing grain, an oxidizing agent, an organic acid and an alkanolamine represented by general formula (1):
NR¹ₘ(R²OH)ₙ (1)
where R¹ is hydrogen or alkyl having 1 to 5 carbon atoms; R² is alkylene having 1 to 5 carbon atoms; m is an integer of 0 to 2 both inclusive; and n is a natural number of 1 to 3 both inclusive, provided that m+n is 3.

2. A slurry for chemical mechanical polishing as claimed in claim 1, wherein the alkanolamine is at least one selected from the group consisting of ethanolamine, diethanolamine and triethanolamine.

3. A slurry for chemical mechanical polishing as claimed in claim 1, wherein a content of the alkanolamine is 0.01 wt % to 10 wt % both inclusive to a total amount of the slurry for chemical mechanical polishing.

4. A slurry for chemical mechanical polishing as claimed in claim 1, wherein a content of the polishing grain is 1 wt % to 30 wt % both inclusive to a total amount of the slurry for chemical mechanical polishing.

5. A slurry for chemical mechanical polishing as claimed in claim 1, wherein a content of the organic acid is 0.01 wt % to 5 wt % both inclusive to a total amount of the slurry for chemical mechanical polishing.

6. A slurry for chemical mechanical polishing as claimed in claim 1, wherein pH is 4 to 8 both inclusive.

7. A slurry for chemical mechanical polishing as claimed in claim 1, wherein a content of the oxidizing agent is 0.01 wt % to 15 wt % both inclusive to a total amount of the slurry for chemical mechanical polishing.

8. A slurry for chemical mechanical polishing as claimed in claim 1, comprising an antioxidant in an amount of 0.0001 wt % to 5 wt % both inclusive to a total amount of the slurry for chemical mechanical polishing.
